(19) United States
(12) Patent Application Publication
(10) Pub. No.: US 2016/0125202 A1
(43) Pub. Date: May 5, 2016

(54) Method for operating a control device

(71) Applicant: Robert Bosch GmbH, Stuttgart (DE)

(72) Inventors: Christopher Pohl, Duesseldorf (DE); Hamit Hacioglu, Stuttgart (DE); Frederic Stumpf, Stuttgart (DE)

(21) Appl. No.: 14/884,280

(22) Filed: Oct. 15, 2015

(30) Foreign Application Priority Data
Oct. 30, 2014 (DE) 10 2014 222 181.1

(51) Int. Cl. G06F 21/71; G06F 9/50

(52) U.S. Cl. CPC G06F 21/71; G06F 9/5038

(57) ABSTRACT

A method for operating a control device having a system-on-a-chip having a processor unit and a security processor unit, the processor unit and the security processor unit each having at least one processor core, the processor unit instructing the security processor unit to execute security-critical processes, a priority being assigned, by the processor unit or by the security processor unit, to each of the security-critical processes that are to be executed in the security processor unit, and the security-critical processes being executed in the security processor unit as a function of the respective priority.

### RELATED APPLICATION INFORMATION

The present application claims priority to and the benefit of German patent application no. 10 2014 222 181.1, which was filed in Germany on Oct. 30, 2014, the disclosure of which is incorporated herein by reference.

### FIELD OF THE INVENTION

The present invention relates to a method for operating a control device that has a system-on-a-chip having a processor unit and a security processor unit, as well as a computing unit and a computer program for the execution thereof.

### BACKGROUND INFORMATION

A system-on-a-chip (one-chip system, SoC) is an integrated circuit (IC) in which a large number of functions of a corresponding system are integrated on a single chip (die). Such SoCs can include a processor unit (processor system part, PS). Such a processor unit can include a functional processor or processor core, or a multicore processor. Multicore processors include a plurality (at least two) of processor cores. A processor core in most cases includes an arithmetic-logical unit (ALU), which represents the actual electronic computing mechanism for executing tasks, programs, computing commands, etc., and in addition a local memory.

In addition to the processor unit, an SoC can also include a so-called hardware security module (HSM). Analogous to the conventional processor unit, this HSM can also include one or more processor cores as well as local memories (ROM, RAM, flash, EEPROM). An HSM thus has separate physical resources (processor core(s), local memories, etc.) that are independent of the physical resources of the processor unit. The resources of the HSM can in particular be shielded relative to the resources of the processor unit at the hardware level.

An HSM is an insulated, secure environment that is protected against manipulation and attacks, inter alia from the processor unit, and can therefore be used in particular for security-critical processes or operations. In the course of such security-critical or cryptographic processes, security-critical data can be processed and/or created, such as signatures, encryptions, etc.

It can be advantageous to integrate such an SoC with a processor unit and an HSM in a control device, in particular in a control device of a motor vehicle, such as an engine control device. However, in most cases conventional HSMs are unsuitable for use in such control devices, and cannot ensure that safety requirements and safety standards that hold in the automotive field will be met.

For example, in a control device it can be required that particular processes, in particular security-critical processes, meet a real-time condition, i.e. that a result of these processes is guaranteed to be calculated within a defined time interval, i.e. the result is present before a specified time limit. However, in most cases using conventional HSMs it cannot be ensured that security-critical processes will meet a real-time condition.

It is therefore desirable to provide a possibility for implementing a system-on-a-chip having a processor unit and a hardware security module in a control device, in particular in a control device of a motor vehicle.

### SUMMARY OF THE INVENTION

According to the present invention, a method is proposed for operating a control device having the features described herein. Advantageous embodiments are the subject matter of the further descriptions and of the following description.

The control device is in particular fashioned as a control device of a motor vehicle, for example as an engine control device. The control device includes a system-on-a-chip (SoC) having a processor unit and a security processor unit, each including at least one processor core. The processor unit and the security processor unit each include in particular protective mechanisms against changes in voltage, changes in clock pulse, and changes in temperature.

In addition, the processor unit and the security processor unit each include in particular a local memory, for example a flash, ROM, RAM, and/or EEPROM memory. Alternatively or in addition, in particular a common local memory can also be provided for the processor unit and the security processor unit. In this case, in particular a memory security mechanism is provided, for example a memory protection unit (MPU). Such a memory security mechanism manages the access to this common memory, and protects the common memory from manipulation and attacks. In particular, such a memory security mechanism realizes an isolation of memory regions for the processor unit and for the security processor unit in the common memory.

The security processor unit is in particular fashioned as a hardware security module (HSM). The security processor unit and processor unit are in particular independent of one another, and each have separate physical resources (processor core(s), local memory, etc.). The security processor unit is in particular shielded at the hardware level, and represents a secure environment that is protected against manipulation and attacks, or at least is intended to make manipulations or attacks more difficult.

The processor unit can instruct the security processor unit to carry out security-critical processes. The processor unit and security processor unit are in communicative connection, in particular via a communications system, for example a functional bus or a commonly used memory or communication registers or a combination thereof.

Security-critical processes, or cryptographic processes, are to be understood in particular as processes in which security-critical data are processed and/or produced that, as a whole or in part, are not intended to leave the SoC or are not intended to reach third parties, for example the secret keys required for certain operations. For example, one or more of the following processes or operations can be regarded as such security-critical processes: generation and/or checking of a signature; encryption and/or decryption of data; application of a hash algorithm; generation of codes and/or passwords; authentication and/or verification of messages, control commands, and/or control values; storage of security-critical data.

According to the present invention, a respective priority is assigned to the security-critical processes that are to be executed in the security processor unit, and the security-critical processes are executed in the security processor unit as a function of their respective priority. In particular, the processor unit itself assigns a respective priority to a corresponding security-critical process when the processor unit instructs the security processor unit to execute this security-critical process. It is also conceivable for the security processor unit to assign the respective priority to the security-critical processes that are to be executed.

In particular, individual processor cores of the processor unit instruct the security processor unit to execute the corresponding security-critical processes. For example, an operating system executed in the respective processor core of the processor unit can correspondingly instruct the security processor unit. Processes or operations or applications that are in particular not security-critical can also be executed in the individual processor cores of the processor unit. It is also conceivable for these processes to correspondingly directly instruct the security processor unit.

In particular, in the security processor unit a flow chart or sequence can be created (scheduling), according to which the various security-critical processes are executed. In particular, the security-critical processes are executed in decreasing order of their respective priority. In particular, security-critical processes having higher priority are executed first, and security-critical processes having lower priority are executed last.

### Advantages of the Invention

The present invention enables a flexible planning of the security-critical processes that are to be executed. Through the present invention, relevant security-critical processes whose execution is of high importance and is to be carried out as quickly as possible are distinguished from those security-critical processes that are less important and whose execution is not urgent and does not have to be carried out as quickly as possible.

In particular, due to the present invention it is not necessary for the security processor unit to execute security-critical processes in the sequence in which they were instructed to be executed. Relevant security-critical processes having high priority can be executed before security-critical processes that are less important and that have lower priority. In particular, the security processor unit in each case executes only a single safety-critical process, and not a plurality of them simultaneously. The present invention makes it possible to rationally use the resources of the security processor unit and to execute the security-critical processes in accordance with their importance and relevance.

Conventional hardware security modules also cannot simultaneously execute a plurality of processes. Conventional hardware security modules, it can in some circumstances be necessary to wait until a process currently executed in the HSM has terminated before a new process can be started. Depending on the currently executed process, it can in some circumstances take a comparatively long time, for example up to several seconds, until a new process can be started. Accordingly, in some cases it may be necessary first to wait up to several seconds before an important security-critical process can be executed.

Through the present invention, such problems of conventional hardware security modules can be corrected. Relevant security-critical processes whose execution is of high importance, and that are to be executed as quickly as possible, are given a high, or highest, priority. These security-critical processes are executed in the security processor unit first and as quickly as possible. In this way, it can be ensured that urgently required security-critical data can be created or processed as quickly as possible.

An advantageously large number of different priorities, or different priority levels, is conceivable. The greater the number of different priorities that can be assigned to security-critical processes, the better the relevance of the various security-critical processes can be distinguished.

In particular, through the present invention it can be ensured that safety requirements and safety standards that hold in the field of motor vehicles can be met. In particular, the present invention enables real-time capability of the security processor unit. Therefore, the present invention is suitable in particular for control devices of a motor vehicle, for example for an engine control device. Through the present invention, attacks on and manipulations of the control device can be prevented.

In the case of a control device of a motor vehicle, in particular a “know-how protection” can be ensured, and manipulations of the control device software, such as for example in the case of “chip tuning,” can be prevented.

In particular, in the course of the security-critical processes data are processed and/or created that are required for the controlling and operation of the motor vehicle, for example specific control commands, technical data, control or characteristic values. These commands or values have often been determined and optimized by the manufacturer in years-long development processes, with high research outlay, through long-term expensive series of tests. Thus, the manufacturer has an interest in guaranteeing a “know-how protection” so that these data cannot be read by a third-party attacker.

In the course of a “chip tuning,” an attacker tries to manipulate the executed security-critical processes, modifying control parameters of the control device in order to cause increases in output. This can cause damage to components and environmental pollution, and even to personal injury, because the entire vehicle design (drive system, braking system) can be impaired.

Advantageously, the execution of a security-critical process having low priority is interrupted and continued later in favor of a security-critical process having high priority. The security processor unit is not strictly and necessarily bound to the produced flow chart or the produced sequence of the security-critical processes that are to be executed. In particular, the flow chart or sequence can be modified at any time, and individual security-critical processes can be flexibly redistributed in the flow chart or sequence as needed.

If, in the security processor unit, a first security-critical process having a first priority is executed, and if the processor unit instructs the security processor unit to execute a second security-critical process having a second priority that is higher than the first priority, the execution of the first security-critical process in the security processor unit may be interrupted or paused, and the second security-critical process is executed in the security processor unit.

This can in particular take place automatically as soon as the security processor unit receives a corresponding instruction to call a security-critical process having a higher priority. Advantageously, the current progress of the execution of the first security-critical process is saved and (completely) stored, for example in the local memory (ROM, RAM, flash, EEPROM) of the security processor unit.

After execution of the second security-critical process, which may be the execution of the first security-critical process, is continued in the security processor unit. The execution is advantageously continued directly from the saved current level of progress. In this way, no data of the first security-critical process are lost, and the execution does not have to be restarted. The execution of the first security-critical process may be continued automatically without requiring further interaction of the processor unit.

If, during the execution of the second security-critical process, the execution of one or more further security-critical processes is instructed, to each of which further processes higher priorities have been assigned than to the first security-critical process, but to which lower priorities have been assigned than to the second security-critical process, then after execution of the second security-critical process which may be first this further security-critical process is executed, and the first security-critical process continues to be interrupted or paused.

Advantageously, the security processor unit has a real-time capability. Security-critical processes that are to be executed in real time are executed in the security processor unit in such a way that a real-time condition is met. This real-time condition is defined in particular in the standard DIN 44300. These security-critical processes are guaranteed to be completely executed by the security processor unit within a specified defined time interval. A result of these security-critical processes is guaranteed to be calculated within this defined time interval, and is accordingly present before a particular time limit. In addition, a determinism, or predictability, of these security-critical processes is present.

In the security processor unit, in addition to such security-critical processes that are to be executed in real time, it is also possible to execute security-critical processes that do not have to meet a real-time condition. Security-critical processes that are to be executed in real time may be assigned a higher priority than security-critical processes that are not to be executed in real time.

In particular, the real-time capability of the security processor unit can be ensured through the possibility of interrupting the execution of a security-critical process having lower priority in favor of a security-critical process having higher priority, and to resume this interrupted execution later. A currently executed lower-priority security-critical process can thus be interrupted in favor of a security-critical process that has to meet a real-time condition. In particular, the priority is assigned to a security-critical process to be executed in real time according to the respective time interval within which this security-critical process has to be executed.

In the security processor unit a real-time-capable operating system may be executed. Such a real-time-capable operating system can execute computing operations (e.g. processes, tasks, applications, etc.) in such a way that a corresponding real-time condition is met. In particular, the real-time-capable operating system meets the real-time condition defined according to the standard DIN 44300. Accordingly, in particular programs for processing data to be processed or security-critical processes that are to be executed are constantly ready for operation, in such way that the results of these processings are available within a specified time span. Depending on the case of application, the data can be provided for processing according to a temporally random distribution, or at predetermined times.

A computing unit according to the present invention, e.g. a system-on-a-chip or a control device of a motor vehicle, is set up, in particular with regard to programming, in order to execute a method according to the present invention.

The implementation of the method in the form of software is also advantageous because this results in particularly low costs, in particular if an executing control device is used for further tasks and is therefore already present. Suitable data carriers for providing the computer program are in particular diskettes, hard drives, flash memories, EEPROMs, CD-ROMs, DVDs, and others. Downloading of a program via computer networks (Internet, intranet, etc.) is also possible.

Further advantages and embodiments of the present invention result from the description and the accompanying drawing.

Of course, the features named above and to be explained below can be used not only in the respectively indicated combination, but also in other combinations, or by themselves, without departing from the scope of the present invention.

The present invention is shown schematically in the drawing on the basis of exemplary embodiments, and is explained in detail in the following with reference to the drawing.

### BRIEF DESCRIPTION OF THE DRAWINGS

FIG. 1 schematically shows an embodiment of a control device according to the present invention.

FIG. 2 schematically shows an specific embodiment of a method according to the present invention as a time-priority diagram.

FIG. 3 schematically shows an specific embodiment of a method according to the present invention as a time-priority diagram.

### DETAILED DESCRIPTION

FIG. 1 shows an exemplary embodiment of a control device according to the present invention, shown schematically and designated 150. Control device 150 is for example fashioned as an engine control device of a motor vehicle, set up to execute an engine controlling of an internal combustion engine of the motor vehicle.

Control device 150 has a system-on-a-chip (SoC) 100. SoC 100 includes a processor unit 110 and a security processor unit 120.

Processor unit 110 includes a multicore processor having three processor cores 111, 112, and 113. A local memory 114, 115, or 116, for example a flash memory, is allocated to each processor core 111, 112, or 113. Security processor unit 120 includes a processor core 121 and a local memory having a RAM memory 122 and a ROM memory 123.

Alternatively, a common local memory (e.g. RAM, EEPROM, flash) of security processor unit 120 and processor unit 110 can be provided, as well as a memory security mechanism (e.g. a memory protection unit) that manages the access to this common memory.

Processor unit 110 and security processor unit 120 are two independent individual processor units. Security processor unit 120 is shielded at the hardware level and is protected against manipulation and attacks. In security processor unit 120, a real-time-capable operating system is executed. Processor unit 110 and security processor unit 120 are in communicative connection with one another via a bus 117.

Various applications can be executed in processor cores 111, 112, 113 of processor unit 110. In the course of these applications, security-critical data may have to be produced and/or processed that are required for the controlling and operation of the motor vehicle, for example specific control commands, technical data, control or characteristic values.

These security-critical data must not leave control device 150 and must not come into the possession of third parties. In addition, it must be ensured that certain of these security-critical data are produced in real time. For this purpose, control device 150 is set up to execute a specific embodiment of a method according to the present invention.

In the course thereof, the respective applications that are executed in processor cores 111, 112, 113 of processor unit 110 and that are to produce or process the security-critical data instruct security processor unit 120 to execute particular security-critical processes. Here, the applications assign a respective priority to the security-critical processes. Security processor unit 120 executes the various security-critical processes as a function of the respective priority. In the course of these security-critical processes, the respective security-critical data are produced or processed in security processor unit 120.

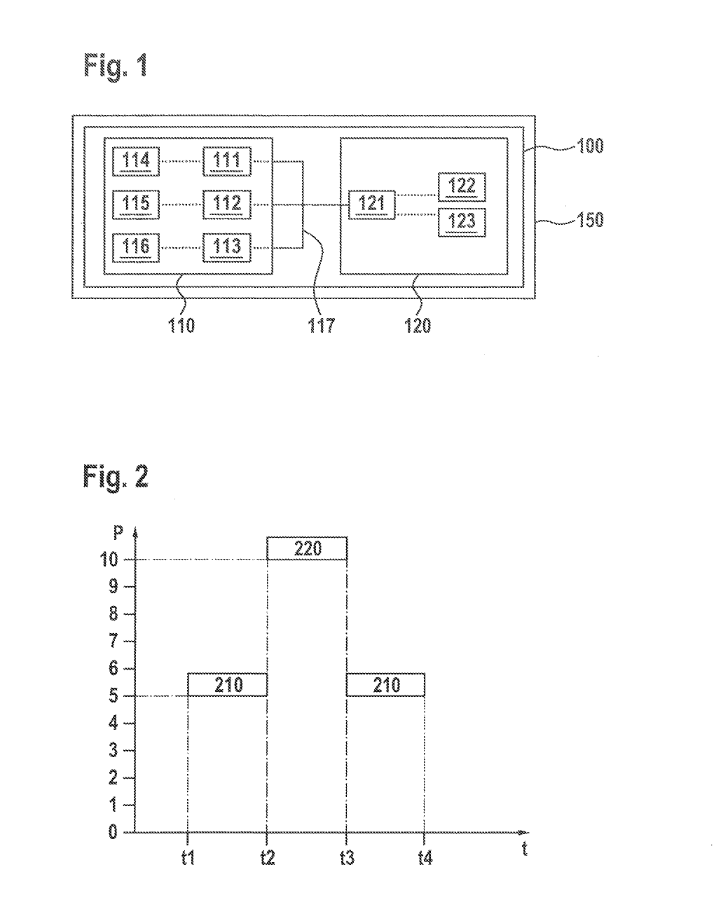

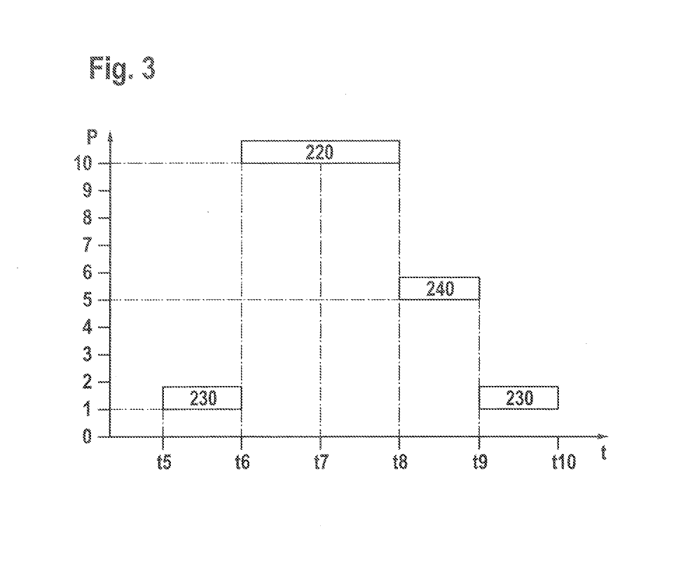

In the following, a specific embodiment of the method according to the present invention is described on the basis of FIGS. 2 and 3. FIGS. 2 and 3 each schematically show a time-priority diagram. On the ordinate, in each case a priority P is plotted that can be assigned to various security-critical processes. On the abscissa, in each case a time t is plotted. Security-critical processes having assigned priorities that are executed in security processor unit 120 between specified times are shown in the time-priority diagram as bars.

In the following, a first example of the specific embodiment of the method according to the present invention is described in the basis of FIG. 2.

At a first time t1, a first application, executed in processor core 111, instructs security processor unit 120 to execute a first security-critical process 210. In the course of this first security-critical process 210, a verification of a message or a checking of an authentication code of a message that was sent to engine control device 150 by a further control device of the motor vehicle is to be carried out. This first process 210 is not intended to be carried out in real time. The first application assigns this first process 210 a first, medium priority of for example 5.

At first time t1, security processor unit 120 begins to execute this first process 210. At a second time t2, at which the execution of first process 210 has not yet terminated, a second application executed in processor core 112 instructs security processor unit 120 to execute a second security-critical process 220.

In the course of this second security-critical process 220, a fuel injection quantity and a composition of a fuel-air mixture are to be determined for the internal combustion engine. This second process 220 is a relevant process that is very important for error-free operation of the motor vehicle. This second process 220 is to be executed in real time. The second application assigns to this second process 220 a second, comparatively high priority, for example 10.

Because this second priority is higher than the first priority, at time t2 security processor unit 120 interrupts the execution of first process 210 and instead executes second process 220. The progress of first process 210 is stored by security processor unit 120.

At a third time t3, the execution of second process 220 is terminated. At third time t3, security processor unit 120 continues the execution of first process 210 from the progress level of time t2. At a fourth time t4, the execution of first process 210 is terminated.

In the following, a second example of the specific embodiment of the method according to the present invention is described on the basis of FIG. 3.

At a fifth time t5, a third application, executed in processor core 111, instructs security processor unit 120 to execute a third security-critical process 230. In the course of this third security-critical process 230, a monitoring for a chip tuning is to be carried out, i.e. a check as to whether control parameters of control device 150 have been modified in order to bring about an increase in performance. This check is not to be carried out in real time. The third application assigns to this third process 230 a third, comparatively low priority, for example a priority of 1.

At fifth time t5, security processor unit 120 begins to execute third process 230. At a sixth time t6, at which the execution of third process 230 has not yet terminated, the second application issues a renewed instruction to security processor unit 120 to execute the second security-critical process 220, in order to make a new determination of the fuel injection quantity and the composition of the fuel-air mixture for the internal combustion engine. The second application again assigns to the second process 220 the second, high priority of for example 10.

Because the second priority is higher than the third priority, at time t6 security processor unit 120 interrupts the execution of third process 230, and instead executes second process 220. The progress level of third process 230 is saved by security processor unit 120.

At a seventh time t7, the first application instructs security processor unit 120 to execute a fourth security-critical process 240. In the course of this fourth security-critical process 240, data are to be encrypted and provided with an authentication code that is to be communicated to a further control device of the motor vehicle. This fourth process 240 is not to be executed in real time. The first application assigns to this fourth process 240 a fourth priority of for example 5.

Because this fourth priority is lower than the second priority, at time t7 security processor unit 120 does not interrupt the execution of second process 220.

At an eighth time t8, the execution of second process 220 is terminated. Because the fourth priority is higher than the third priority of third process 230, at time t8 security processor unit 120 does not continue the execution of third process 230, but instead begins the execution of fourth process 240.

At a ninth time t9, the execution of fourth process 240 is terminated. At ninth time t9, security processor unit 120 continues the execution of third process 230 from the progress level of time t6. At a tenth time t10, the execution of third process 230 is terminated.

What is claimed is:

1. A method for operating a control device having a system-on-a-chip having a processor unit and a security processor unit, the method comprising:
instructing, via the processor unit, the security processor unit to execute security-critical processes, the processor unit and the security processor unit each having at least one processor core;
assigning a priority, by the processor unit or by the security processor unit, to each of the security-critical processes that are to be executed in the security processor unit; and
executing the security-critical processes in the security processor unit as a function of the respective priority.

2. The method of claim 1, wherein:
if a first security-critical process having a first priority is executed in the security processor unit, and if the processor unit instructs the security processor unit to execute a second security-critical process having a second priority that is higher than the first priority,
the execution of the first security-critical process in the security processor unit is interrupted,
the second security-critical process is executed in the security processor unit, and
after execution of the second security-critical process, the execution of the first security-critical process in the security processor unit is continued.

3. The method of claim 2, wherein, when the execution of the first security-critical process in the security processor unit is interrupted, the current progress level of the execution is saved, and after execution of the second security-critical process the execution of the first security-critical process in the security processor unit is continued from this saved current progress level.

4. The method of claim 3, wherein the execution of the first security-critical process in the security processor unit is continued from this saved current progress level autonomously, without intervention of the processor unit.

5. The method of claim 1, wherein safety-critical processes that are to be executed in real time in the security processor unit are executed so that a real-time condition is met.

6. The method of claim 5, wherein the security-critical processes that are to be executed in real time are assigned a higher priority than security-critical processes that are not to be executed in real time.

7. The method of claim 1, wherein a real-time-capable operating system is executed in the security processor unit.

8. A computing unit for operating a control device having a system-on-a-chip having a processor unit and a security processor unit, comprising:
the processor unit to instruct the security processor unit to execute security-critical processes, the processor unit and the security processor unit each having at least one processor core; and
the processor unit or the security processor unit assigning a priority to each of the security-critical processes that are to be executed in the security processor unit;
wherein the security-critical processes are executed in the security processor unit as a function of the respective priority.

9. A computer readable medium having a computer program, which is executable by a processor, comprising:
a program code arrangement having program code for operating a control device having a system-on-a-chip having a processor unit and a security processor unit, by performing the following:
instructing, via the processor unit, the security processor unit to execute security-critical processes, the processor unit and the security processor unit each having at least one processor core;
assigning a priority, by the processor unit or by the security processor unit, to each of the security-critical processes that are to be executed in the security processor unit; and
executing the security-critical processes in the security processor unit as a function of the respective priority.

10. The computer readable medium of claim 9, wherein:
if a first security-critical process having a first priority is executed in the security processor unit, and if the processor unit instructs the security processor unit to execute a second security-critical process having a second priority that is higher than the first priority,
the execution of the first security-critical process in the security processor unit is interrupted,
the second security-critical process is executed in the security processor unit, and
after execution of the second security-critical process, the execution of the first security-critical process in the security processor unit is continued.
